(19) United States
(12) Patent Application Publication
(10) Pub. No.: US 2015/0155761 A1
(43) Pub. Date: Jun. 4, 2015

(54) Electronically Commutated Electromagnetic Apparatus

(71) Applicant: Douglas Richard, Lynwood, IL (US)

(72) Inventor: Douglas Richard, Lynwood, IL (US)

(21) Appl. No.: 14/293,933

(22) Filed: Jun. 2, 2014

Related U.S. Application Data
(60) Provisional application No. 61/910,230, filed on Nov. 29, 2013.

(51) Int. Cl. H02K 11/00; H02K 1/16

(52) U.S. Cl. CPC H02K 11/0073; H02K 1/16

(57) ABSTRACT

The electronically commutated electromagnetic apparatus (ECA) of the present invention is a direct current (DC) rotating electro-magnetic machine that converts electrical energy into mechanical energy when operating as a motor and mechanical into electrically energy as a generator. The ECA has a slot to slot commutation combined with a unique prime numbered concentric winding layout which mitigates alternating current (AC) losses at extremely high speeds and torque ripple at extremely low speeds. Applications include compact low cost, high speed centrifugal compressors and very low speed direct drive wind turbines.

### RELATED APPLICATIONS

This application claims priority to U.S. Provisional Patent Application No. 61/910,230, filed on Nov. 29, 2013, a copy of which is included herein by reference in its entirety.

### BACKGROUND OF THE INVENTION

Conventional brushless motors are designed to operate using six solid state switches which simulate three phase power exciting the windings producing a rotating magnetic wave with a period equal to the span or width of one pole. This configuration is limited by alternating current (AC) losses proportional to the square of the frequency or speed (rpm) such that extremely high speeds produce prohibitively high AC losses. If large amounts of torque are required at slow speeds, the diameter has to be of sufficient size to accommodate a high pole count. Conventional brushed direct current (DC) motors have a shorter slot to slot commutation period which mitigates AC losses but friction resulting from contact between the brushes and commutator limit its rotational speed and reliability while increasing maintenance costs. The stationary armature machine disclosed in U.S. Pat. No. 6,873,084, which is incorporated by reference herein in its entirety, was developed by transposing the armature and field to combine the advantages of simple DC controls and the power density of AC machines using a mechanical system of rotating brushes and static commutator. Other prior art include a new electric machine technology defined as a “Permanent Magnet Direct Current Machine with Integral Reconfigurable Winding Control”. Significant improvements include topologies of magnetic circuits, windings and the solid state switching and control system to replace the commutator, brushes and external power converter. This electric machine concept is optimized to utilize slot path commutation characteristics to produce high torque and power density combined with very high efficiency. The specific air gap field distribution and winding layout combined with the internally connected controls, or electronic commutation, is defined as the “slot path” method. The coils in a slot path circuit can be described as a static armature having a means for reconnecting said coils in parallel or series for the purpose of field weakening to reduce back electromotive force (EMF) at high rotational speeds.

### SUMMARY OF THE INVENTION

The advancement of alternative energy technologies have increased the need for high energy, high efficiency electric machines. DC brushed electric machines are inefficient and maintenance intensive, and conventional AC machines are require a more complex external controller. The commutation period also differs between DC and AC machines such that an AC machine's period is measured from pole to pole or width of one pole while a DC machine's period is measured from slot to slot. This is important because applications such as direct drive wind turbines require extremely high torque at extremely slow speeds requiring a large diameter rotor with multiple poles to accommodate the pole to pole commutation period. Locomotive traction motors require high torque at slow speeds and field weakening at high speeds to overcome back electromotive force necessitating the need for slot to slot commutation.

### DESCRIPTION OF THE DRAWINGS

FIG. 1 shows a prior art schematic of an alternating current machine.

FIG. 2 shows a simplified schematic winding layout

FIG. 3 shows a schematic of the multiple step commutated machine

FIG. 3A shows a concentric coil group

FIG. 4 shows schematic of ECA motor with multiple solid state switches

FIG. 4A shows a schematic of a conventional brushed dc motor

FIG. 5 shows the linear electronic switching pattern

FIG. 6 shows the logical electronic switching pattern

### DETAILED DESCRIPTION OF PREFERRED AND ALTERNATE EMBODIMENTS

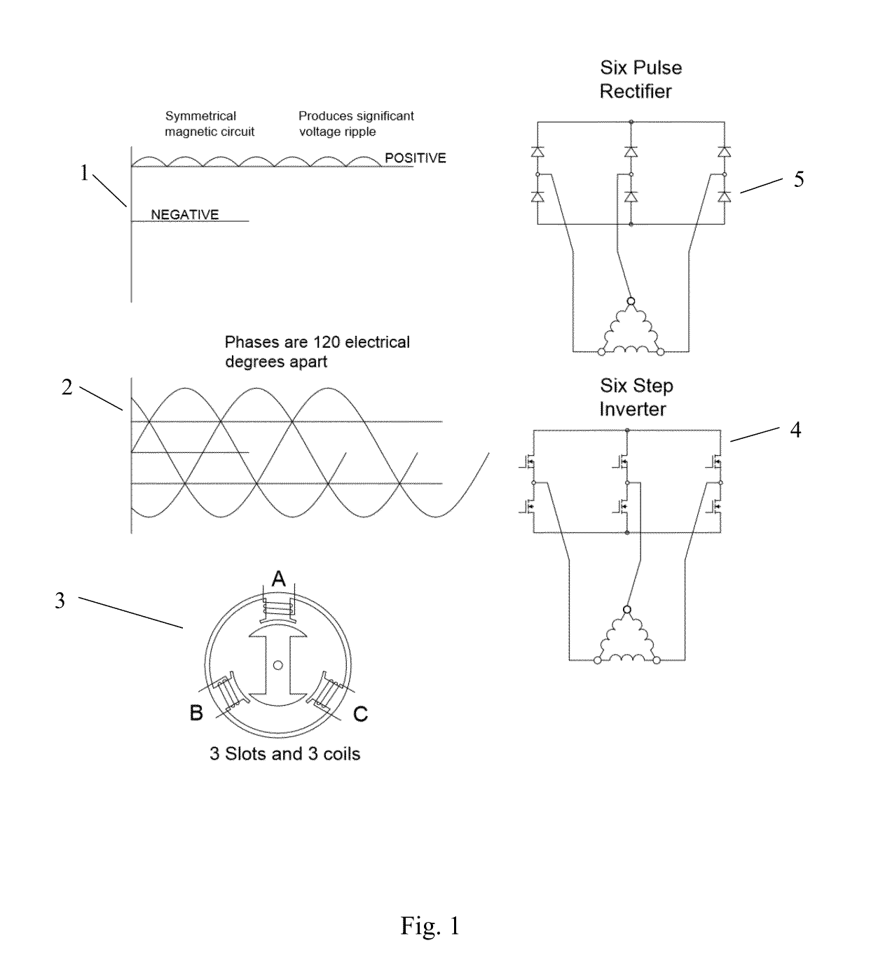

FIG. 1 comprises a conventional three-phase AC machine (1-3) that, when configured with a bridge rectifier (1-5), operates as an alternator. Reference (1-2) shows electrical signals or phases generated exactly 120-electrical degrees apart by rotating the rotor with respect to the stator, and reference (1-1) shows the output resultant of the bridge rectifier with significant voltage ripple. Reference (1-4) shows the solid state switches used to operate the AC machine as a motor or prime mover. The electronic controller comprises two switching methods including six step and sine wave commutation. The brushless topology consists mainly of two electronic switching methods. First, the six-step commutation method is a simple cost-effective means of electronic commutation. Six-step commutation comprises six power solid state switches which are electrically connected to three armature winding sets or phases with only two out of the three phases being energized at one time. Steps are equivalent to 60-electrical degrees, so six steps makes a full, 360-degree rotation. Second, sine wave commutation comprises six power solid-state switches connected in a manner similar to the six step method with the addition of pulse width modulating (PWM) logic to simulate three-phase sine wave power which allows for increased power and higher efficiencies.

Permanent magnet machines are used in many industrial applications due to their ability to generate high power densities. Permanent magnet generators (PMG) are especially useful in relatively new direct drive wind turbines, and are increasingly the focus of research and development in that field. In any application, the interaction of the permanent magnets with the stator teeth or rotor poles in permanent magnet machines can cause cogging torque, which is unwanted pulsation in the shaft torque causing structural vibrations and mechanical failure. Due to symmetry in AC stator geometry and asymmetry in DC armature geometry, cogging torque is generated and varies in magnitude with the angular position of the rotor. Torque ripple is also inherent in AC machines as the instantaneous torque varies with the angular position of the rotor with respect to the stator.

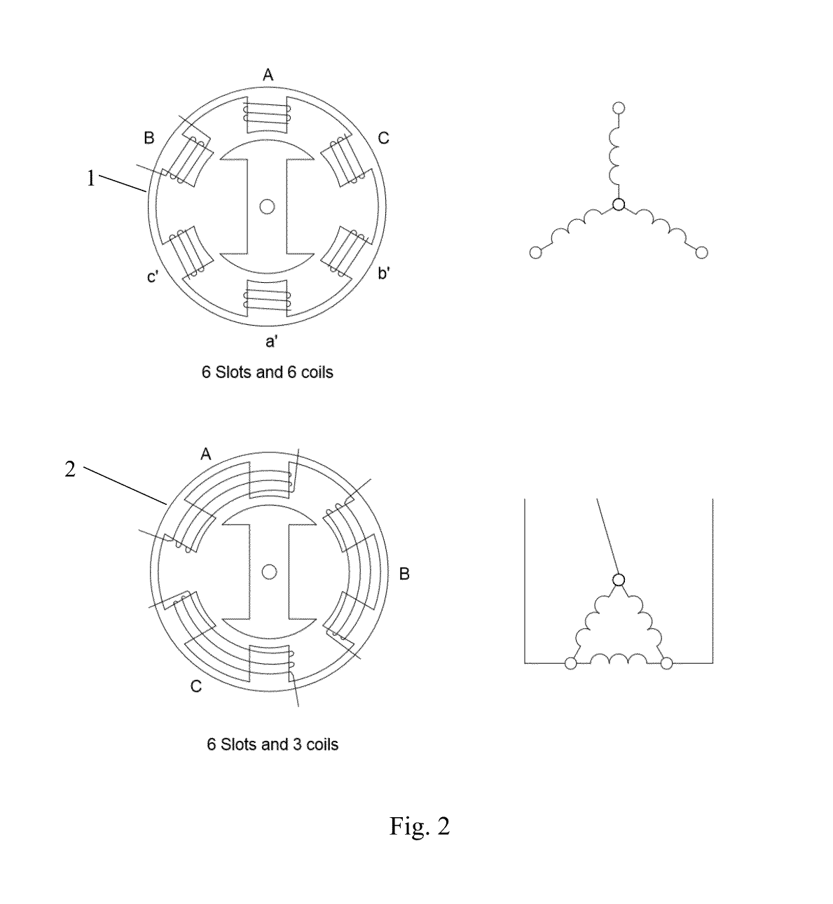

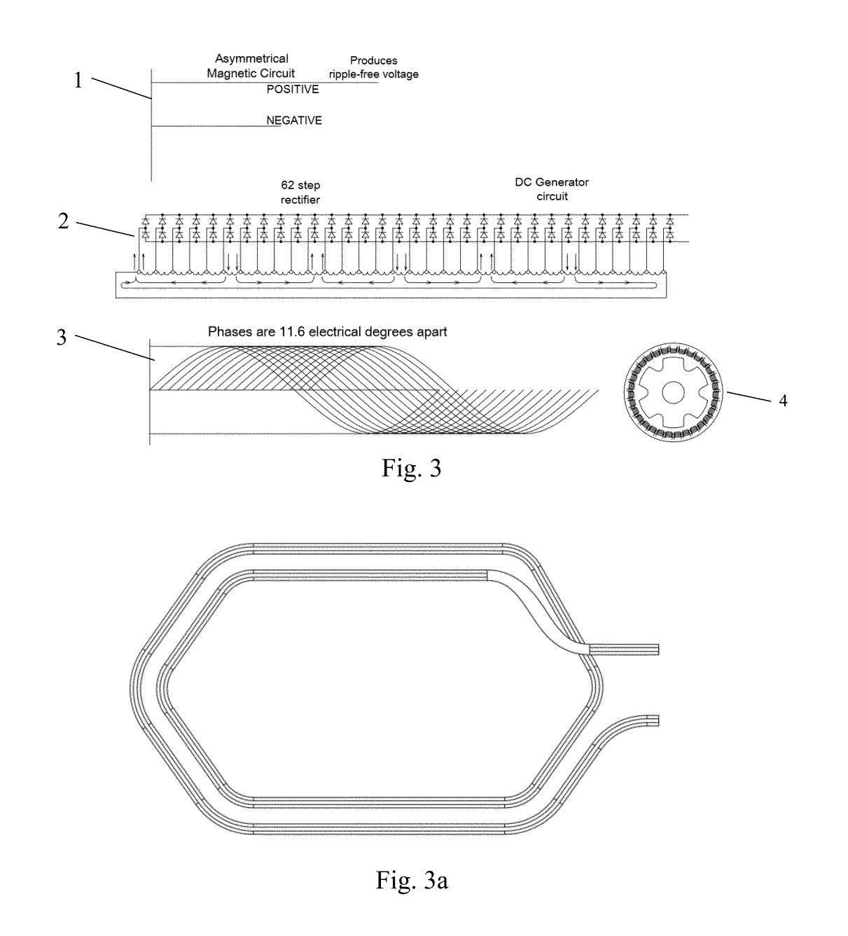

FIG. 2 show the symmetrical stator winding layout of a typical AC machine with a stator (2-1) having equally numbered coils and slots. The coils and electrically connected in a wye configuration. The stator, shown at (2-2), comprises an even numbered slotted stator exactly twice that of the prime numbered winding forming in an asymmetrical magnetically coupled circuit spanning two consecutive poles. Stator winding (2-2) comprising concentric coil groupings, show in FIG. 3A, electrically connected in a closed loop lap-wound configuration and magnetically coupled to rotor topologies including induction squirrel cage, permanent magnet, wound field and homo-polar switched reluctance. The electronically commutated apparatus (ECA) of the present invention has a unique slot to slot multi-step commutation feature which combines the simple, low cost switching logic of the six step commutator with the smoothness, power and efficiency of the sine wave commutator without voltage spikes commonly associated with electronic controllers. The ECA of the present invention comprises a stator, rotor, armature winding and multiple step electronic commutator having winding similar to a DC lap wound armature with closed loop electrical continuity of concentric coil grouping. A plurality of power solid state switches and blocking diodes are connected to taps from each stator coil grouping switched on and off sequentially effectively distributing current density while generating a smooth rotating magnetic field with minimum torque ripple. Using a prime number of concentric coil groupings, the armature is formed by electrically connecting each coil grouping in a lap wound configuration with coil turns embedded in an even number slots exactly double the prime number of coils. This arrangement reduces cogging torque by using symmetrical stator slot geometry to reduce mechanical cogging torque and an asymmetrical, or a prime-numbered winding pattern to eliminate induced eddy or circulating currents.

In FIG. 3, the ECA of the present invention comprises a prime number (3-2) of concentric coil groupings, electrically connected in a closed loop figuration with each tap being connected to a half bridge rectifier eliminating voltage ripple at slow rotational speeds and torque ripple caused by sinusoidal positive and negative peaks. Reference (3-1) shows the resultant output from the plurality of phase signals (3-3) passing through the bridge rectifier forming a DC signal free from voltage. Reference (3-4) shows prime numbered coil grouping and rotor magnetic coupling arrangement with each salient pole representing two slots or exactly twice the prime numbered coil groupings (5-4). This arrangement is useful in the construction of brushless machine topologies not limited to series and or shunt wound field, induction, separately excited, permanent magnet and homo-polar switched reluctance motors and generator with integral controller solid state switches located within the machines frame. A homo-polar topology comprising stationary armature and two field coils located on opposite end of the stator forming a static, three-dimensional toroidal magnetic circuit being magnetically coupled by attraction to a notched ferrous rotor element. Said notched rotor element comprises laminated electrical steel in a simple design to form a high degree of magnetic permeance at the salient poles and high magnetic reluctance within the notched region such that rotation within the static homo-polar magnetic field structure generates an AC signal within the armature. The AC signal's magnitude is regulated by varying current to the static field coils and is rectified into ripple-free DC power (3-1) without the use of brushes or slip rings and is useful for brushless automotive alternators, while the other brushless topology comprises a squirrel cage rotor magnetically coupled by mutual induction to the stator's smooth rotating magnetic field. This arrangement is capable of producing ripple-free, unregulated DC power without brushes or slip rings using only passive solid state diodes (3-2).

FIG. 3A shows a concentric wound coil grouping having an inner set of turns (5-2), surrounding an outer set (5-1) being magnetically coupled to a field structure spanning two consecutive an alternate poles. This arrangement reduces cogging torque and parasitic circulating currents when connected in a lap wound configuration. Leads extending from the concentric coil group in FIG. 3A, are electrically connected to consecutive groups and to its own half bridge solid state switch assembly allowing for multiple points of electrical current injection at each tapped grouping, which when injected in sequence results in a smooth rotating magnetic field. Said rotating magnetic field interacts with a magnetically coupled rotor comprising the field structure. It is important that the coil groupings be concentric to eliminate circulating currents caused by the field structure's magnetic field passing through the closed loop conductor comprised by the stator's coil winding, while the even numbered stator slots provide lower reluctance relative to the magnetically coupled rotating field structure.

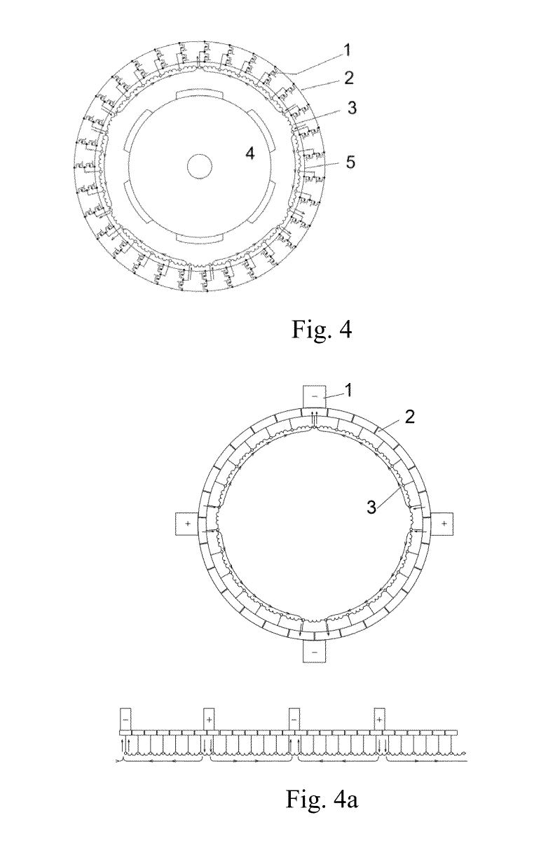

FIG. 4 shows FIG. 3 configured as a motor with power solid state switches. Reference (4-1) is connected in a half bridge arrangement to prime numbered coils (4-3) and magnetically coupled to rotor (4-4). Rotating element (4-4) comprises many topologies including, wound field, induction squirrel cage, permanent magnet and homo-polar switched reluctance. Half bridge solid state switches are connected to DC power input through positive bus (4-2) and negative bus (4-5) and are switched sequentially generating a rotating magnetic wave. Multiple solid state switches effectively distribute electric current density in a form factor suited for inclusion within the machines physical frame simulating the action of a mechanical commutator and brushes. This arrangement can generate large amounts of direct current without parasitic circulating eddy currents or cogging torque having applications in wind turbines and locomotive tractive drives. A high degree of resolution and smoothness are achieved by using a large prime number of concentrically grouped coils (5-1) and (5-2), having the effectiveness of a sine wave commutated machine without using complex algorithms.

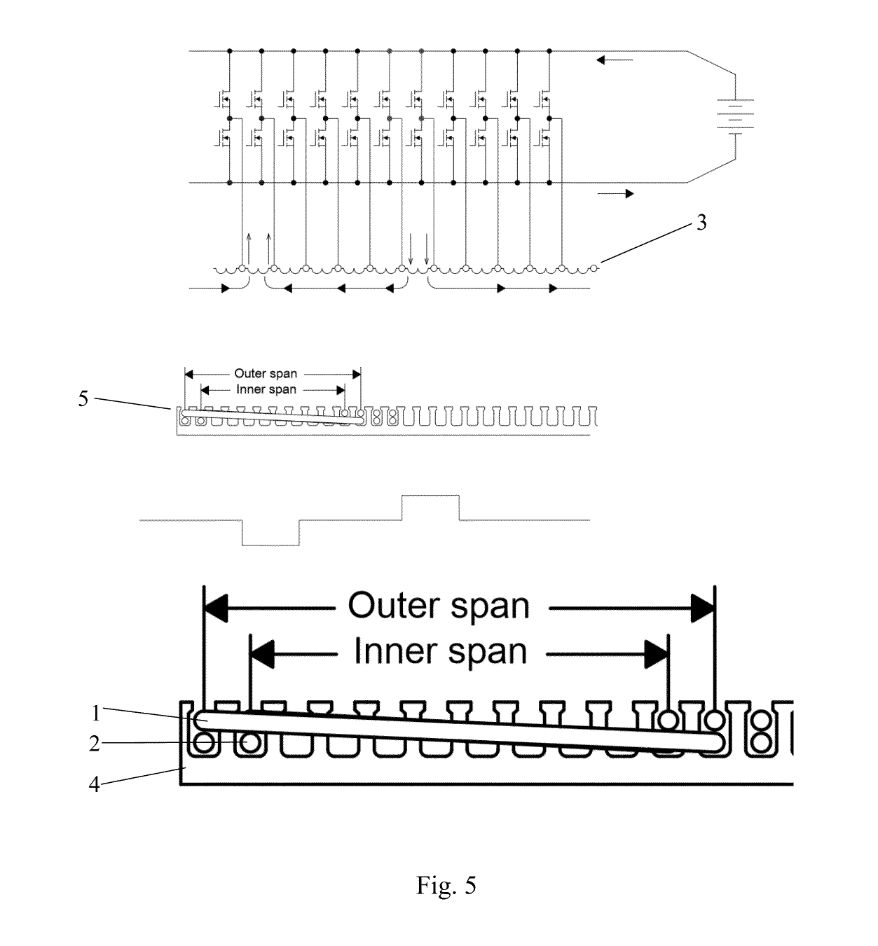

FIG. 5 represents a linear schematic of the ECA of the present invention, having a prime number of coils (5-3) connected to solid state switches being energized in a logical sequence (5-5) to produce a smooth magnetic wave. Very large direct current machines comprising mechanical brushes and commutators, shown in FIG. 4A, use the slot path method because of the simple control methods and high torque generated at a high degree of resolution at slow speeds without the 120 hertz hum of fixed frequency AC machines. The ECA of the present invention expands on the slot path method by transposing the conventional DC machine's armature from the rotor to the stator having an even number of slots (5-4) which are exactly twice the prime numbered coil grouping, shown in FIG. 3A. The stator's even numbered slots effectively reduce cogging torque compared to the conventional prime number slotted DC armature core and equally prime numbered coil windings.

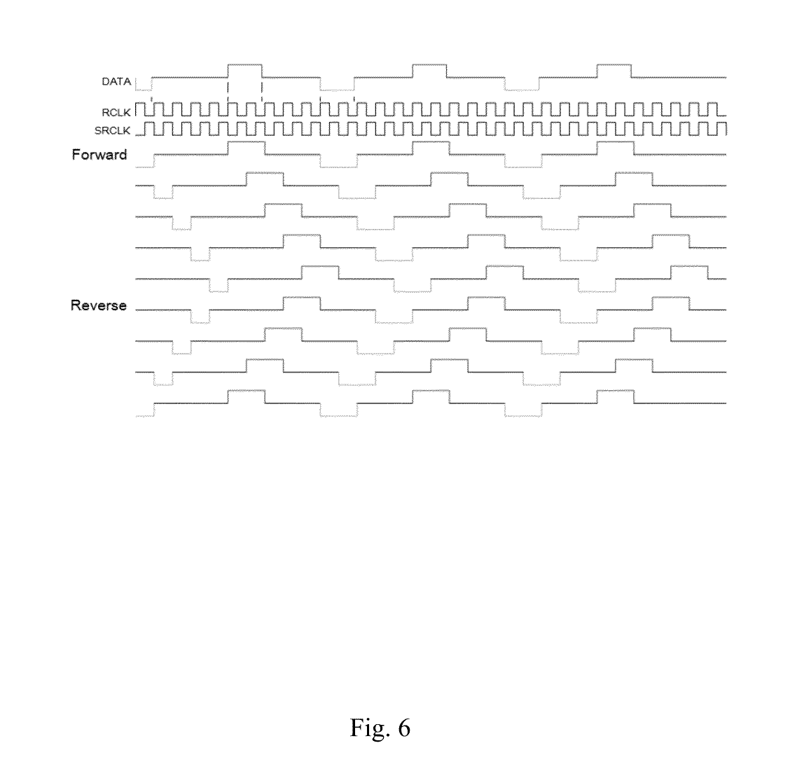

FIG. 6 represents a logical switching sequence in the forward and reverse directions. Low level logical patterns are generated by an electronic controller comprising a microprocessor or discrete components, and sent to an electronic buffer or shift register having outputs equal to the prime numbered coil groupings, shown in FIG. 3A. The shift register excites the pre-driver which turns the solid state power switches on an off in sequence to produce rotation. The speed of rotation is determined by a trim potentiometer remotely located with respect to the solid state power switches. A current limiting feature is comprised of a hall effect sensor, or equivalent means for measuring branch currents through each energized solid state switch. A comparator measures the branch current's magnitude and compares it to a reference and sends a signal to modulate the solid state switches when the reference level is exceeded.

The foregoing embodiments of the present invention have been presented for the purposes of illustration and description. These descriptions and embodiments are not intended to be exhaustive or to limit the invention to the precise form disclosed, and obviously many modifications and variations are possible in light of the above disclosure. The embodiments were chosen and described in order to best explain the principle of the invention and its practical applications to thereby enable others skilled in the art to best utilize the invention in its various embodiments and with various modifications as are suited to the particular use contemplated. It is intended that the invention be defined by the following claims.

What is claimed is:

1. An electronically commutated electromagnetic apparatus comprising:
a rotor;
a slotted stator;
a prime-numbered grouping of concentrically wound copper coils;
the slotted stator having twice the number of slots as the prime-numbered grouping of concentrically would copper coils;
the concentrically wound copper coils spanning two consecutive poles connected in a closed loop lap-wound configuration.

2. The electronically commutated electromagnetic apparatus of claim 1, wherein each grouping of concentrically wound copper coils an inner coil surrounded by an outer coil.

3. The electronically commutated electromagnetic apparatus of claim 2, wherein the inner and outer coils are magnetically coupled to a field structure spanning two consecutive alternate magnetic poles.

4. The electronically commutated electromagnetic apparatus of claim 1, wherein each grouping of concentrically wound copper coils is connected to a half bridge solid state switch.

5. The electronically commutated electromagnetic apparatus of claim 3, wherein the half bridge solid state switch energizes each grouping of concentrically wound coils in a sequential manner with direct current power generating a magnetic wave.

6. The electronically commutated electromagnetic apparatus of claim 1, wherein a resultant output signal from said apparatus contains zero voltage ripple.

7. The electronically commutated electromagnetic apparatus of claim 1, wherein a resultant output signal from said apparatus contains zero torque ripple.

8. An electronically commutated electromagnetic apparatus comprising:
a rotor;
a stator;
a prime number of concentrically grouped electrical coils, each concentrically grouped electrical coils comprising in inner coil surround by an outer coil;
wherein the stator comprises twice the number of slots as the prime-numbered grouping of concentrically wound copper coils.

9. The electronically commutated electromagnetic apparatus of claim 8, wherein the prime-numbered grouping of concentrically wound copper coils span two consecutive poles.

10. The electronically commutated electromagnetic apparatus of claim 9, wherein the two consecutive poles are connected in a closed loop lap-wound configuration.

11. The electronically commutated electromagnetic apparatus of claim 9, wherein the inner and outer coils of each prime-numbered grouping of concentrically wound copper coils are magnetically coupled to a field structure spanning two consecutive alternate magnetic poles.

12. The electronically commutated electromagnetic apparatus of claim 8, further comprising a half bridge solid state switch connected to each grouping of concentrically wound copper coils.

13. The electronically commutated electromagnetic apparatus of claim 9, wherein each concentrically grouped electrical coils contain leads which connect them to a half bridge solid state switch.

14. The electronically commutated electromagnetic apparatus of claim 11, wherein the half bridge solid state switch energizes the coils in a sequential manner with direct current power generating a magnetic wave.

15. The electronically commutated electromagnetic apparatus of claim 12, wherein the half bridge solid state switch rectifies power generated by movement from a magnetically coupled field structure with respect to the each concentrically grouped electrical coils.

16. The electronically commutated electromagnetic apparatus of claim 8, wherein a resultant output signal from said apparatus contains zero voltage ripple and zero torque ripple.

17. An electronically commutated electromagnetic apparatus comprising:
a rotor;
a slotted stator;
a prime number of concentrically grouped electrical coils spanning two consecutive poles connected together in a closed loop lap-wound configuration;
each concentrically grouped electrical coils contains leads connected each coil group to a half bridge solid state switch which energizes each coil group in a concentric manner.

18. The electronically commutated electromagnetic apparatus of claim 17, wherein each concentrically grouped electrical coils have an inner coil surrounded by an outer coil.

19. The electronically commutated electromagnetic apparatus of claim 17, wherein a resultant output signal from said apparatus contains zero voltage ripple.

20. The electronically commutated electromagnetic apparatus of claim 17, wherein a resultant output signal from said apparatus contains zero torque ripple.
